(19) United States
(12) Patent Application Publication
(10) Pub. No.: US 2006/0267948 A1
(43) Pub. Date: Nov. 30, 2006

(54) Liquid crystal display device with tablet function

(75) Inventor: Mitsuasa Takahashi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC LCD Technologies, Ltd.

(21) Appl. No.: 11/441,082

(22) Filed: May 26, 2006

(30) Foreign Application Priority Data
May 30, 2005 (JP) 2005-158215

(51) Int. Cl. G02F 1/1335; G09G 5/00

(52) U.S. Cl. 345/168; 349/12

(57) ABSTRACT

A liquid crystal display device having a tablet function is provided which is capable of reliably preventing malfunction. Light receiving devices are made up of TFTs (Thin Film Transistors) having approximately the same structure as driving switching elements. A semiconductor layer making up the light receiving devices, in particular, is made up of a non-doped a-Si (amorphous silicon) layer and a doped n⁺-type a-Si layer. A gate electrode of each of light receiving TFTs is connected to its own source electrode and to its own drain electrode. This prevents each of the light receiving TFTs from being put, in error, into an ON state. The light receiving TFTs can be kept reliably in an OFF state irrespective of setting of a bias level, which prevents reliably malfunction. By detecting optical currents generated in the light receiving devices, light input positions can be identified accurately and reliably.

### BACKGROUND OF THE INVENTION

1. Field of the Invention

The present invention relates to a liquid crystal display device having a tablet function and more particularly to the liquid crystal display device with the tablet function in which a plurality of light detecting devices to receive outgoing light from a light pen or a like and to detect a position shown by coordinates input by designating the position are formed on a substrate on which pixel electrodes and switching elements are arranged in a matrix form.

The present application claims priority of Japanese Patent Application No. 2005-158215 filed on May 30, 2005, which is hereby incorporated by reference.

2. Description of the Related Art

Conventionally, an information processing device called a “tablet PC (Personal Computer)” in which layers of tablets allowing a position to be input by detecting pressure are deposited on a surface of a liquid crystal panel is being widely used. The conventional tablet PC is, for example, a tablet PC for detection of a position which has an embedded structure in which two pieces of transparent substrates each having a transparent electrode are formed apart by a predetermined distance and arranged so that the transparent electrodes of the transparent substrates face each other and positions of the transparent electrodes having come into contact with each other by being pushed by pressure are detected by a detecting circuit and information about the detected positions is transmitted to a controlling section. Such the conventional tablet PC has problems. That is, since layers of tablets are deposited on a display screen, a display screen is visually recognized as if the display screen has lain deep therein, causing the display screen to become hard to view (due to a “deep window effect”) and also causing the tablet PC to be thick and heavy as a whole.

To solve this problem, a liquid crystal display device is disclosed in, for example, Patent Reference 1 (Japanese Patent Application Laid-open No. Sho 56-085792) which is capable of detecting a position by forming light detecting devices together with switching elements on TFTs (Thin Film Transistors) making up a liquid crystal display panel and by detecting light emitted from a light emitting pen (hereinafter, referred simply to as light pen) or a like using the light detecting devices. As the switching elements for driving, TFTs each having a lateral-type npn structure are used and, as the light detecting devices, phototransistors each having a pnp or npn structure or a p-type or n-type semiconductor of one polarity is used.

In each of the above switching elements, a gate electrode formed on a transparent insulating substrate is coated with a gate insulating film on which a semiconductor layer is formed and a drain electrode and source electrode are formed in a manner in which the drain electrode and source electrode are in contact with the semiconductor layer. The semiconductor layer is made up of a p-type region formed in an upper portion of the gate electrode and an n-type region placed on both sides of the p-type region. The above semiconductor layer is fabricated by performing patterning on an n-type amorphous silicon layer doped with P (phosphorus) to form a source and a drain and further depositing a p-type amorphous silicon layer doped with B (boron).

Here, in the vicinity of an edge in the source and drain, etching of only the p-type amorphous silicon layer formed on a side of an upper layer is required. That is, it is necessary that all the p-type amorphous silicon layers are removed and the n-type amorphous silicon layers having a specified thickness are left. Therefore, etching of the p-type and n-type amorphous silicon layers being the same material for the semiconductor layer according to a selective ratio is needed. The above light detecting devices are formed with the same process as for the switching elements and at the same time when the switching elements are formed.

Moreover, another technology is disclosed in which, in the case of using a semiconductor of one polarity as each of the light detecting devices, when data lines through which displaying signals are supplied to corresponding pixel electrodes are connected to scanning lines to which scanning signals are supplied, the light detecting devices are connected to the scanning lines through the switching elements to be used for reading, in addition to the switching elements to be used for writing to pixels. Each of the switching elements to be used for reading is made up of TFTs as with the switching elements to be used for writing and its drain and source are connected respectively to each of the light detecting devices and to each of scanning lines.

It is here reported that an OFF potential to put the scanning lines into an OFF state is ordinarily about −10 V. The Off potential, based on the phenomenon in which, when the amorphous silicon is used as the material for the semiconductor layer, a leakage current during the OFF state is reduced as a reversely-biased gate voltage drops to about −5 V, is set to prevent leakage of currents from small pixel electrodes. An ON potential to put the scanning lines into an ON state is ordinarily about +20 V. A voltage for writing to pixels to be fed to the signal lines is reported to be several volts.

A problem to be solved in the above conventional technologies is that the light detecting devices are put into an ON state in error in some cases. There are some cases in which, when a phototransistor is used as a light detecting device, the light detecting device is put into the ON state in error, even without irradiation with light from a light pen or a like, due to leaked light from, for example, a backlight. That is, when a bipolar phototransistor is used as a light detecting device, due to use of the phototransistor having a pnp or npn structure with its base being in a floating state, if a potential difference between both terminals (between an emitter and collector) is large, the light detecting device is put into an ON state in error by an effect of a parasitic device in some cases.

Moreover, when a semiconductor of one polarity is used as the light detecting device, if input light is to be detected by connecting TFTs serving as the switching elements for reading to the light detecting device, malfunction including unwanted operations occurs in some cases. For example, when a scanning line on a subsequent row of a specified pixel is selected and put into an ON state, since a displaying signal is supplied to a pixel on the same column immediately below the above specified pixel along a surface of the TFT substrate, each of the switching elements for reading whose gate is connected to the same signal line which corresponds to the above specified pixel is put in the ON state, thus causing unwanted operations.

A switching element corresponding to an unselected pixel on the same column other than the above specified pixel is put into an ON state in the same manner as above. In this case, the switching element for reading does not perform its original function, causing current consumption to be wastefully increased. Thus, depending on a way of setting a bias voltage, the switching element for reading corresponding to an unselected light receiving device is also put into an ON state, which, as a result, causes malfunction.

### SUMMARY OF THE INVENTION

In view of the above, it is an object of the present invention to provide a liquid crystal display device having a tablet function which is capable of reliably preventing malfunction when input light is to be detected.

According to a first aspect of the present invention, there is provided a liquid crystal display device with a tablet function including:

scanning lines to which scanning signals are applied;

signal lines to which displaying signals are applied;

pixel electrodes arranged in a matrix form to apply voltages to a liquid crystal layer;

switching elements each made up of a field effect transistor formed in a vicinity of each intersection of each of the scanning lines and each of the signal lines to switch a displaying signal to be applied to corresponding one of the pixel electrodes by using scanning signals; and

coordinate position detecting devices each formed in a manner to correspond to at least part of each of the pixel electrodes to output a coordinate position detecting signal to specify a coordinate position designated by a position designating unit when receiving light emitted through a display screen from the position designating unit;

wherein the coordinate position detecting devices are made up of field effect transistors.

In the foregoing, a preferable mode is one wherein a gate electrode of each of the coordinate position detecting devices is connected to its own drain electrode or to its own source electrode.

Also, a preferable mode is one wherein a pair of the coordinate position detecting devices are formed so as to be symmetric with each other using the drain electrode or source electrode as common electrodes.

Also, a preferable mode is one wherein each of the switching elements and each of the coordinate position detecting devices have approximately the same layered structure.

Also, a preferable mode is one that wherein includes an optical current measuring unit to receive the coordinate position detecting signals and to measure optical currents generated by the coordinate position detecting devices.

Also, a preferable mode is one that wherein includes first wirings and second wirings connected to the coordinate position detecting devices to read the coordinate position detecting signals output from the coordinate position detecting devices, wherein each of the coordinate position detecting devices is formed in a vicinity of each intersection of each of the first wirings and each of the second wirings and the drain electrode or the source electrode of each of the coordinate position detecting devices is connected to each of the first wirings or each of the second wirings.

Also, a preferable mode is one that wherein includes a controlling unit to select the coordinate position detecting devices to detect presence or absence of light input and to connect the optical current measuring unit to the selected coordinate position detecting devices through the first wirings and the second wirings and a coordinate position specifying unit to specify coordinate positions input by designation of the position designating unit based on the coordinate position detecting signals output from the coordinate position detecting devices.

Also, a preferable mode is one wherein each of the scanning lines or each of the signal lines serves as at least one out of each of the first wirings and each of the second wirings.

Also, a preferable mode is one wherein each of the coordinate detecting devices is connected to each of the scanning lines serving as each of the first wirings and to each of the signal lines serving as each of the second wirings.

Also, a preferable mode is one wherein the driving controlling unit, during a writing suspending period in which the switching elements are in an OFF state, selects the coordinate position detecting devices corresponding to the switching elements as coordinate detecting devices being objects of reading coordinate position detecting signals.

Also, a preferable mode is one wherein a semiconductor of each of the coordinate position detecting devices includes a first amorphous silicon layer which is not doped with impurity and a second amorphous silicon layer which is formed on the first amorphous silicon layer and is doped with n-type or p-type impurity.

Furthermore, a preferable mode is one wherein the position designating unit includes a light pen.

With the above configurations, coordinate position detecting devices each formed in a manner to correspond to at least part of the pixel electrodes, when receiving light emitted from a position designating unit that inputs a coordinate position by designation using light, output coordinate position detecting signals to specify the coordinate position input by designation of the position designating unit and each of the coordinate position detecting devices is made up of field effect transistors and, therefore, malfunction occurring at a time of detecting input light can be reliably prevented.

### BRIEF DESCRIPTION OF THE DRAWINGS

The above and other objects, advantages, and features of the present invention will be more apparent from the following description taken in conjunction with the accompanying drawings in which:

FIG. 1 is an equivalent circuit diagram showing electrical configurations of a liquid crystal panel according to a first embodiment of the present invention;

FIG. 2 is a perspective view schematically showing configurations of the liquid crystal panel of FIG. 1;

FIG. 3 is a cross-sectional view schematically showing configurations of the liquid crystal panel of FIG. 1;

FIG. 4 is a schematic block diagram showing electrical configurations of a liquid crystal display device using the liquid crystal display panel of FIG. 1;

FIG. 5 is a plan view showing configurations of a TFT substrate used in the liquid crystal display panel of FIG. 1;

FIG. 6 is a cross-sectional view of the liquid crystal panel of FIG. 1 taken from a line A-A in FIG. 5;

FIG. 7 is an equivalent circuit diagram showing electrical configurations of a liquid crystal panel according to a second embodiment of the present invention;

FIG. 8 is a plan view showing configurations of TFTs of the liquid crystal display panel of FIG. 7;

FIG. 9 is a cross-sectional view of the liquid crystal panel of FIG. 7 taken from a line B-B in FIG. 8; and

FIG. 10 is an equivalent circuit diagram showing electrical configurations of a liquid crystal panel according to a third embodiment of the present invention.

### DETAILED DESCRIPTION OF THE PREFERRED EMBODIMENTS

Best modes of carrying out the present invention will be described in further detail using various embodiments with reference to the accompanying drawings. According to the present invention, coordinate position detecting devices each formed in a manner to correspond to at least part of pixel electrodes, when receiving light emitted from a position designating means that inputs a coordinate position by designation using light, output coordinate position detecting signals to specify the coordinate position input by designation of the position designating means and each of the coordinate position detecting devices is made up of a field effect transistor and, therefore, a purpose of reliably preventing malfunction occurring at a time of detecting input light is achieved.

### First Embodiment

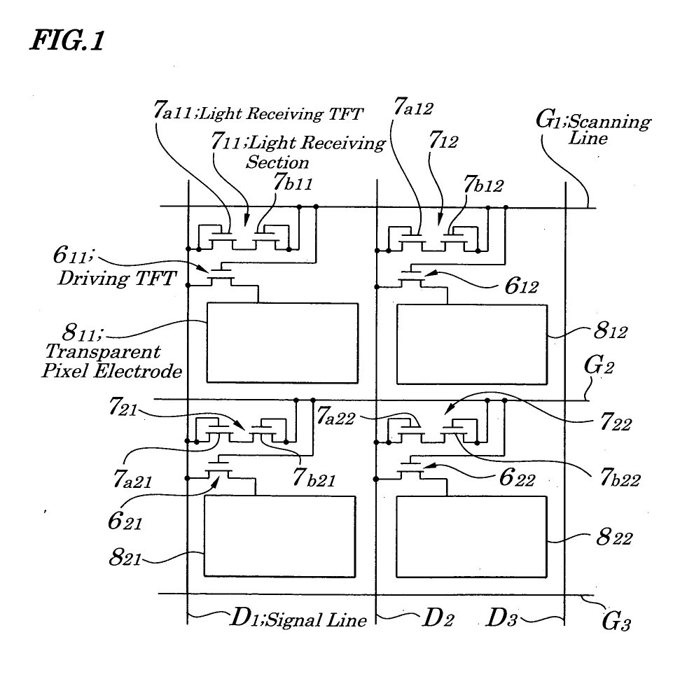

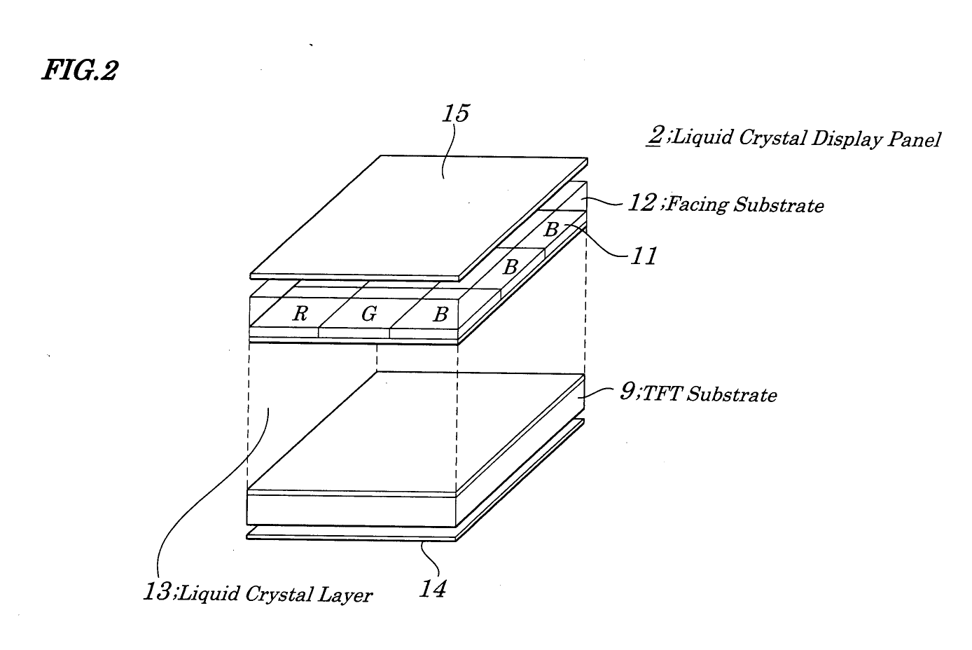

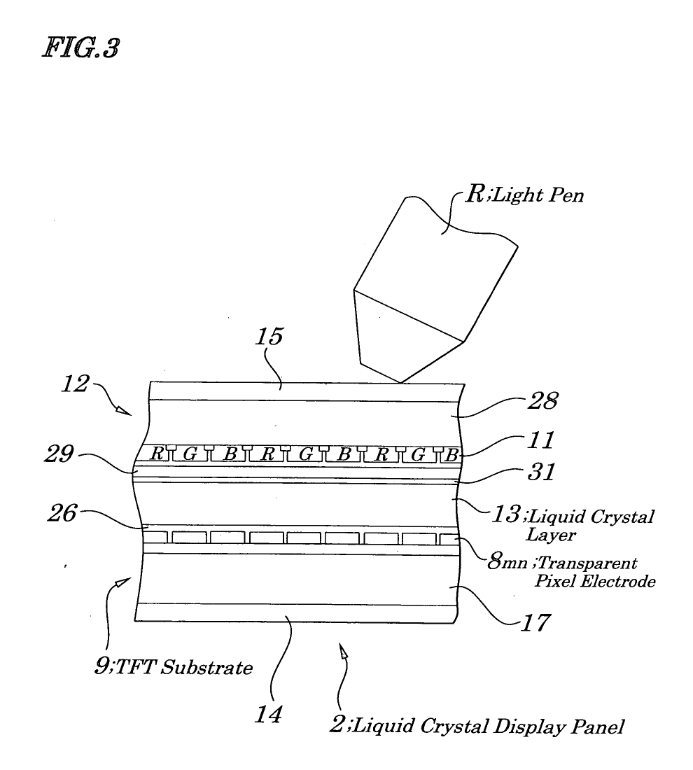

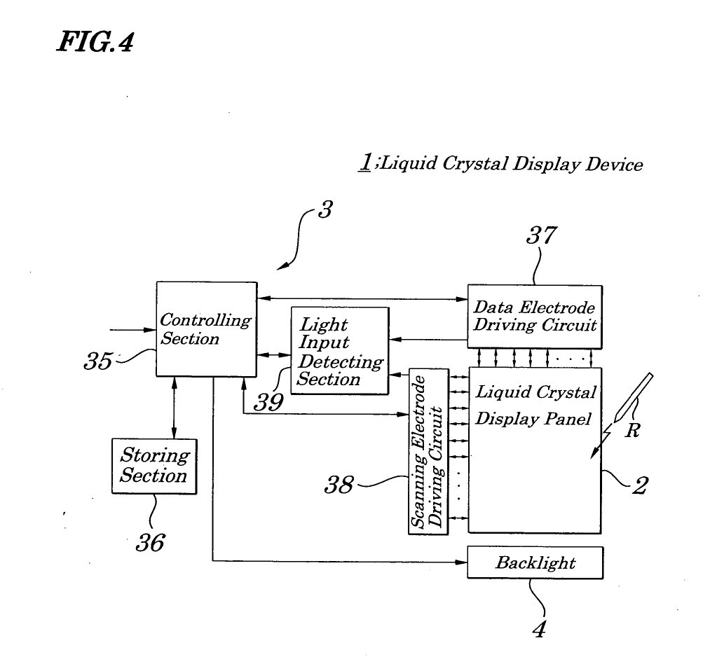

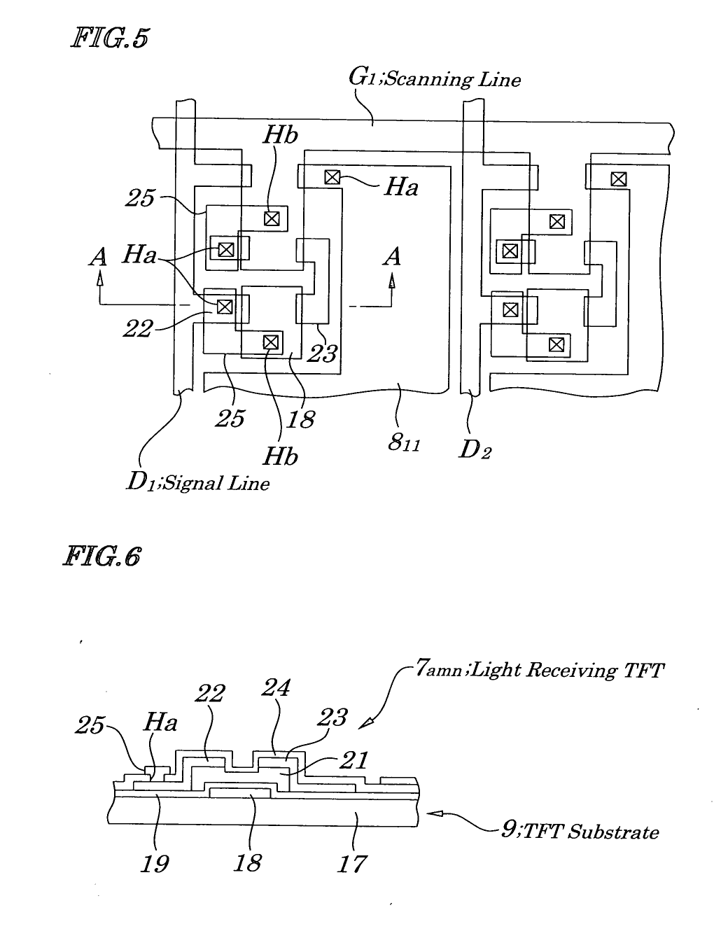

FIG. 1 is an equivalent circuit diagram showing electrical configurations of a liquid crystal panel of the first embodiment of the present invention. FIG. 2 is a perspective view schematically showing configurations of the liquid crystal panel of FIG. 1. FIG. 3 is a cross-sectional view schematically showing configurations of the liquid crystal panel of FIG. 1. FIG. 4 is a schematic block diagram showing electrical configurations of a liquid crystal display device using the liquid crystal display panel of FIG. 1. FIG. 5 is a plan view showing configurations of a TFT substrate used in the liquid crystal display panel of FIG. 1. FIG. 6 is a cross-sectional view of the liquid crystal panel of FIG. 1 taken from a line A-A in FIG. 5.

The liquid crystal display device 1 of the first embodiment is used, for example, as an inputting device or displaying device for a tablet PC and includes, as shown in FIGS. 2 to 4, a liquid crystal display panel 2, an LCD (Liquid Crystal Display) driving circuit 3 to drive a liquid crystal display panel 2 and a backlight 4 to supply illuminating light to the liquid crystal display panel 2, and has a displaying function and a function of inputting coordinate position information by using a light pen R serving as, for example, a position designating means (pointing device). The liquid crystal display panel 2 is a transmissive-type liquid crystal panel having, for example, a TFT structure. The liquid crystal display panel 2, as shown in FIGS. 1 to 3, includes driving TFTs 6ₘₙ (“m” and “n” are a natural number), light receiving sections 7ₘₙ each being made up of a pair of light receiving TFTs 7ₐₘₙ and 7_{bmn}, a TFT substrate 9 on which a plurality of transparent pixel electrodes 8ₘₙ is formed, a facing substrate 12 formed so as to be opposite to the TFT substrate 9 in a fixed manner with a clearance of several μm being interposed between the TFT substrate 9 and the facing substrate 12 on which coloring layers (color filters) 11 are formed, a liquid crystal layer 13 put in the clearance in a hermetically sealed manner and a pair of polarizers 14 and 15 attached to an outside of each of the TFT substrate 9 and facing substrate 12. Moreover, the subscript “m” in the driving TFTs 6ₘₙ or the like denotes a number of the row and “n” denotes a number of the column. For example, each of the driving TFTs 6ₘₙ shows that it is each driving TFT placed on the “m” row and “n” column and connected to the m-th line of the scanning lines Gₘ and to the n-th line of the signal lines Dₙ.

On the TFT substrate 9 are formed a plurality of transparent pixel electrodes 8₁₁, 8₁₂, . . . , in a matrix form and, in an area surrounding each of the plurality of transparent pixel electrodes 8₁₁, 8₁₂, . . . are provided each of the scanning lines Gₘ to supply scanning signals and each of the signal lines Dₙ to supply displaying signals so that each of the scanning lines Gₘ and each of the signal lines Dₙ intersect at right angles. Each of the above scanning signals and each of the above displaying signals are input from external inputting terminals connected to external circuits. Each of the driving TFTs 6ₘₙ and each of the light receiving TFTs 7ₐₘₙ and 7_{bmn} are formed in the vicinity of each intersection of each of the scanning lines Gₘ and each of the signal lines Dₙ. A source electrode of each of the driving TFTs 6ₘₙ is connected to each of the transparent pixel electrodes 8ₘₙ and each of the driving TFTs 6ₘₙ is used as each switching element to apply a signal charge to each corresponding liquid crystal cell. Each of the light receiving TFTs 7ₐₘₙ and 7_{bmn} is used as a coordinate position detecting device (light receiving device) to receive light emitted from the light pen R.

Each of the driving TFTs 6ₘₙ is driven and controlled by inputting of a scanning signal through each of the scanning lines Gₘ to a gate electrode connected to each of the scanning lines Gₘ and by inputting of a displaying signal (data signal) to a drain electrode connected to each of the signal lines Dₙ. Also, the source electrode of each of the driving TFTs 6ₘₙ is connected through each of contact holes to each of the transparent pixel electrodes 8ₘₙ. Each of the driving TFTs 6ₘₙ is shielded, if necessary, from light emitted from an upper direction. In the embodiment, each of the light receiving sections 7ₘₙ is made up of a pair of each of the light receiving TFTs 7ₐₘₙ and each of the light receiving TFTs 7_{bmn} in which each of the light receiving TFTs 7ₐₘₙ and each of the light receiving TFTs 7_{bmn} are connected to each other. That is, a gate electrode of each of the light receiving TFTs 7ₐₘₙ is connected to its own drain electrode and to each of the signal lines Dₙ and a source of each of the light receiving TFTs 7ₐₘₙ is connected to a drain electrode of each of the light receiving TFTs 7_{bmn}. Also, a gate electrode of each of the light receiving TFTs 7_{bmn} is connected to its own source electrode and each of the scanning lines Gₘ and a drain electrode of each of the light receiving TFTs 7_{bmn} is connected to the source electrode of each of the light receiving TFTs 7ₐₘₙ.

Thus, since the gate electrode of each of the light receiving TFTs 7ₐₘₙ is connected to their own drain electrode and the gate electrode of each of the light receiving TFTs 7_{bmn} is connected to its own source electrode, the light receiving section 7ₘₙ, even when being strongly biased, can be reliably kept in an OFF state. In the embodiment, each of the driving TFTs 6ₘₙ and each of the light receiving TFTs 7ₐₘₙ and 7_{bmn} have almost the same structure and are formed simultaneously by the same processes, and the semiconductor layer, in particular, is made up of an amorphous silicon (hereinafter simply called “a-Si”) layer serving as the first a-Si layer without being doped and an a-Si layer (hereinafter simply called “n⁺-type a-Si”) serving as the second n⁺-type a-Si layer doped with P (phosphorus) being n⁺-type impurity.

The TFT substrate 9 has a structure in which layers of each electrode and insulating films are deposited on a transparent insulating substrate (panel substrate) 17. That is, as shown in FIGS. 5 and 6, a gate electrode 18 is formed on the transparent insulating substrate 17. The gate electrode 18 is coated with a gate insulating film 19. A semiconductor layer 21 is formed on the gate insulating film 19 on an upper side of the gate electrode 18ₘₙ A drain electrode 22 and a source electrode 23 are formed on the gate insulating film 19 in a manner in which both the drain electrode 22 and source electrode 23 are in contact with the semiconductor layer 21. The gate insulating film 19, semiconductor layer 21, drain electrode 22, and source electrode 23 are coated with a passivation film 24. Specified regions of the passivation film 24 are coated with an ITO (Indium Tin Oxide) film 25. Moreover, each of the contact holes on the drain electrode 22 side and the source electrode 23 side is shown by the reference marks “Ha” and each of the contact holes on the gate electrode 18 by the reference marks “Hb”. Here, the scanning lines Gₘ are formed on the same layer as the gate electrode 18 is formed. The gate electrode 18 formed in a region where the light receiving TFTs 7ₐₘₙ and 7_{bmn} are arranged intercepts illuminating light emitted from the backlight 4 to perform also a function of preventing the light receiving TFTs 7ₐₘₙ and 7_{bmn} from being irradiated with needless light.

By the above processes, the driving TFTs 6ₘₙ and light receiving TFTs 7ₐₘₙ and 7_{bmn} are formed on the transparent insulating substrate 17. As shown in FIG. 3, the specified regions of the ITO film 25 are transparent pixel electrodes 8ₘₙ. A liquid crystal oriented film 26 is formed on the transparent pixel electrode 8. (ITO film 25) in a manner to coat the transparent pixel electrodes 8ₘₙ. On the facing substrate 12 are arranged coloring layers 11 including, for example, red layers, green layers, and blue layers in a mosaic form so that the coloring layers 11 coat a transparent insulating substrate 28, and a facing electrode 29 is formed in a manner to coat the coloring layers 11. Furthermore, a liquid crystal oriented film 31 is formed in a manner to coat the facing electrode 29. The TFT substrate 9 and the facing substrate 12 are formed in a manner in which the liquid crystal oriented film 26 faces the liquid crystal oriented film 31 and a liquid crystal layer 13 is sandwiched between the liquid crystal oriented film 26 and liquid crystal oriented film 31.

The LCD driving circuit 3 has, for example, a CPU (Central Processing Unit) and includes, as shown in FIG. 4, a controlling section 35 to control each component, a storing section 36 made up of a semiconductor memory such as a ROM (Read-Only Memory), RAM (Random Access Memory) to store processing programs to be executed by the controlling section 35 and/or various data including graphics and/or character patterns input by light, or a like, a data electrode driving circuit 37 to supply displaying signals (data signals) to each of the signal lines Dₙ, a scanning electrode driving circuit 38 to supply scanning signals to each of the scanning lines Gₘ. and a light input detecting section 39 to detect input by light from the light pen R by measuring optical currents flowing through each of the light receiving sections 7ₘₙ.

The controlling section 35 controls the data electrode driving circuit 37 and the scanning electrode driving circuit 38 to perform operations of writing to each pixel and selects the light receiving sections 7ₘₙ which are not performing operations of writing to a corresponding pixel (that is, the light receiving sections 7ₘₙ corresponding to pixels in an OFF state) and, in order to detect presence or absence of light input, controls the light input detecting section 39, data electrode driving circuit 37, scanning electrode driving circuit 38 SO that a closed circuit is formed by the scanning lines Gₘ and signal lines Dₙ corresponding to the selected light receiving sections 7ₘₙ and by a corresponding current measuring circuit (not shown) of the light input detecting section 39. The controlling section 35 can select, as objects for which light input is to be detected, the light receiving sections 7ₘₙ (all the light receiving sections 7ₘₙ on rows and columns other than rows and columns to which the light receiving sections 7ₘₙ performing operations of writing to corresponding pixel 7ₘₙ belong) except the light receiving sections 7ₘₙ being connected to the scanning lines Gₘ and signal lines Dₙ to which the light receiving sections 7ₘₙ performing operations of writing to corresponding pixels are connected. At this time point, supply of the scanning signals and displaying signals to the scanning lines Gₘ and signal lines Dₙ to which the light receiving sections 7ₘₙ having been selected as objects for which light input is to be detected is suspended.

In the embodiment, the controlling section 35, when operations of writing to pixels corresponding to the light receiving sections 7₁₁ are performed, selects the light receiving sections 7₂₂, 7₂₃, . . . 7₃₂, 7₃₃, . . . , which are not connected to the scanning line G₁ and signal line D₁. For example, the controlling section 35 selects one of the scanning lines Gₘ to be obtained by changing the row number “m” in increasing order from 1 and by one and alternately performs writing processing and light input detecting processing. That is, the controlling section 35 selects the scanning line G₁ and, after-processing of writing to pixels connected to the scanning line G₁, selects the light receiving section 7₁ₙ connected to the scanning line G₁ and performs light input detecting processing on all the light receiving sections 7₁ₙ on the same row at almost the same time and then selects the scanning line G₂ and, after the completion of writing processing, performs light input detecting processing and, thereafter, sequentially selects the scanning lines Gₘ obtained by changing the row number “m” by one and performs writing processing and light input detecting processing as well.

The controlling section 35, based on measuring signals sent from the light input detecting section 39, specifies a position (coordinates) designated by the light pen R. The light input detecting section 39 has, for example, a plurality (corresponding to the number of signal lines “n”) of current measuring circuits (not shown) and each of the current measuring circuits switches currents flowing through the plurality (corresponding to the number of scanning lines “m”) of the light receiving sections 7ₘₙ connected to the same signal lines Dₙ and measures the current for each column. In the embodiment, currents flowing through the light receiving sections 7ₘₙ connected to the same scanning lines Gₘ are measured at almost the same time. Each of the current measuring circuits measures optical currents (ordinarily, 1000 times larger than dark currents flowing at time of non-emission) flowing through corresponding light receiving sections 7ₘₙ at a time of emission.

The backlight 4 has, for example, a light source unit made up of a plurality of LEDs (light emitting diodes), a light guiding plate to receive light emitted from the light source unit and to emit planar illuminating light toward the liquid crystal display panel 2, a diffusing sheet to compensate for variations in luminance, and an optical material group including a prism sheet to gather illuminating light incident from the light guiding plate side in which illuminating light is emitted to the liquid crystal display panel 2 from its rear side and a viewer visually recognizes light transmitted through the liquid crystal panel 2.

Next, a method for fabricating the TFT substrate 9 of the embodiment is described by referring to FIG. 6. First, as shown in FIG. 6, a film of chromium, used as a gate electrode forming material, with a thickness of about 200 nm is deposited, by using a sputtering method, on the glass-made transparent insulating substrate 17 prepared through cleaning by an ultrasonic cleaning method or a like and patterning is photolithographically performed to form the gate electrode 18. For example, the gate electrode 18 is commonly used for the driving TFTs 6ₘₙ and light receiving TFTs 7_{bmn}. Then, the gate insulating film 19 is formed by depositing a silicon nitride film or a silicon oxide film with a thickness of about 400 nm on whole surfaces of the transparent insulating substrate 17 and the gate electrode 18 by using a CVD (Chemical Vapor Deposition) method or sputtering method.

Next, a film of non-doped a-Si with a thickness of about 250 nm and a film of n⁺-type a-Si doped with P with a thickness of about 50 nm are deposited successively by the CVD method and patterning is performed photolithographically on these films and an RIE (Reactive Ion Etching) method to form the semiconductor layer 21 and the a-Si layer and n⁺-type a -Si layer are left in a region needed for forming the driving TFTs 6 and light receiving TFTs 7, and 7_{bmn} Then, a film of chromium with a thickness of about 200 nm to be used as a material for formation of the drain and source electrodes is deposited on the semiconductor layer 21 by the sputtering method and this chromium film is patterned photolithographically and by etching using a cerium nitrate etchant to form the source electrode 23 and drain electrode 22. Next, etching to a depth of about 100 nm is performed by a PE (plasma etching) method using an etching gas containing sulfur hexafluoride (SF₆) and hydrogen chloride (HCl) so that all the n⁺-type a-Si in a channel portion is removed.

Then, a film of silicon nitride with a thickness of about 150 nm is deposited by the CVD method to form a passivation film 24 and the silicon nitride film is etched photolithgrahically by using, for example, a hydrofuloric acid etchant to form contact holes Ha and Hb.

Next, the ITO film 25 is deposited on the passivation film 24 by the sputtering method and the ITO film 25 is etched by using an aqua regia etchant and patterned photolithographically to form the transparent pixel electrodes 8ₘₙ.

Operations of the liquid crystal display device 1 of the embodiment are described by referring to FIGS. 3 and 4.

The controlling section 35 controls the data electrode driving circuit 37 and the scanning electrode driving circuit 38 to perform operations of writing to each pixel and selects the light receiving sections 7ₘₙ which are not performing operations of writing to a corresponding pixel (that is, the light receiving sections 7ₘₙ corresponding to pixels in an OFF state) and, in order to detect presence or absence of light input, controls the light input detecting section 39, data electrode driving circuit 37, and scanning electrode driving circuit 38 SO that a closed circuit is formed by the scanning lines Gₘ and signal lines Dₙ corresponding to the selected light receiving sections 7ₘₙ and by a corresponding current measuring circuit (not shown) of the light input detecting section 39.

The controlling section 35 can select the light receiving sections 7ₘₙ (all the light receiving sections 7ₘₙ on rows and columns other than rows and columns to which the light receiving sections 7ₘₙ performing operations of writing to corresponding pixels belong) except the light receiving sections 7ₘₙ being connected to the scanning lines Gₘ and signal lines Dₙ to which the light receiving sections 7ₘₙ performing operations of writing to corresponding pixels are connected. At this time point, supply of the scanning signals and displaying signals to the scanning lines Gₘ and signal lines Dₙ to which the light receiving sections 7ₘₙ having been selected as objects for which light input is detected is suspended.

In the embodiment, the controlling section 35, when operations of writing to pixels corresponding to the light receiving sections 7₁₁ are performed, selects the light receiving sections 7₂₂, 7₂₃, . . . , 7₃₂, 7₃₃, . . . , which are not connected to the scanning line G₁ and signal line D₁.

For example, the controlling section 35 selects one of the scanning lines Gₘ to be obtained by changing the row number “m” in increasing order from 1 and by one and alternately performs writing processing and light input detecting processing. That is, the controlling section 35 selects the scanning line G₁ and, after the processing of writing to pixels connected to the scanning line G₁, selects the light receiving section 7₁ₙ connected to the scanning line G₁ and performs light input detecting processing on all the light receiving sections 7₁ₙ on the same row at almost the same time and then selects the scanning line G₂ and, after the completion of writing processing, performs light input detecting processing and, thereafter, sequentially selects the scanning lines Gₘ obtained by changing the row number “m” by one and performs writing processing and light input detecting processing as well.

Each of the current measuring circuits switches currents flowing through the plurality (corresponding to the number of scanning lines “m”) of the light receiving sections 7ₘₙ connected to the same signal lines Dₙ and measures the current for each column. In the embodiment, currents flowing through the light receiving sections 7ₘₙ connected to the same scanning lines Gₘ are measured at almost the same time. Each of the current measuring circuits measures optical currents (ordinarily, 1000 times larger than dark currents flowing at time of non-emission of light) flowing through corresponding light receiving sections 7ₘₙ at a time of emission of light. Here, at the time of non-emission of light, the light receiving TFTs 7ₐₘₙ and 7_{bmn}, since their gate electrodes 18 are connected to their own source electrode 23 or to their own drain electrode 22, is reliably kept in the OFF state, irrespective of setting of a bias level. The controlling section 35, based on measuring signals sent from the light input detecting section 39, specifies a position (coordinates) designated by the light pen R.

Thus, according to the configurations of the first embodiment, the TFTs having approximately the same structure as the driving switching elements are used as the light receiving device and its semiconductor layer, in particular, is made up of a non-doped a-Si layer and n⁺-type a-Si layer and, therefore, unlike in the conventional case of using, for example, a bipolar phototransistor as the light receiving device, there is no erroneous occurrence of an ON state (parasitic turn-on).

Moreover, each of the light receiving TFTs 7ₐₘₙ and 7_{bmn}, since its gate electrode is connected to its own source electrode or its own drain electrode, irrespective of setting of a bias level, can be reliably kept in an OFF state. As a result, malfunction can be reliably prevented when input light is to be detected. Also, it is made possible to reliably and accurately specify a light input position by detecting optical currents generated in the light receiving TFTs 7ₐₘₙ and 7_{bmn}. Furthermore, the light receiving TFTs 7ₐₘₙ and 7_{bmn}, since at least its gate electrode intercepts light emitted from the backlight 4, is able to prevent malfunction caused by illuminating light.

### Second Embodiment

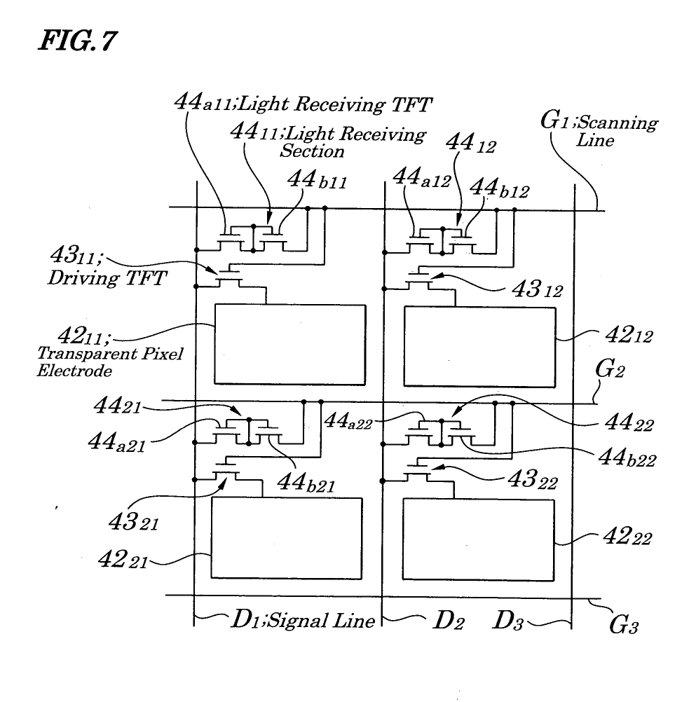

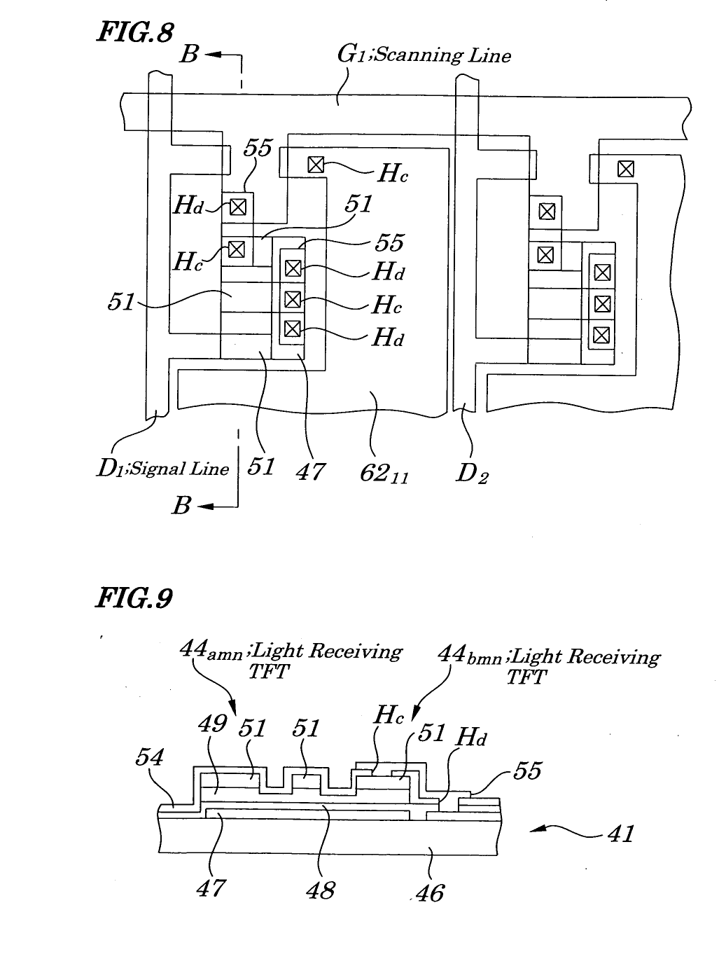

FIG. 7 is an equivalent circuit diagram showing electrical configurations of a liquid crystal panel of the second embodiment of the present invention. FIG. 8 is a plan view showing configurations of TFTs of the liquid crystal display panel of FIG. 7. FIG. 9 is a cross-sectional view of the liquid crystal panel of FIG. 7 taken from a line B-B in FIG. 8. Configurations of the second embodiment differ greatly from those of the first embodiment in that its light receiving section is made up of a pair of light receiving TFTs in which gate electrodes are connected to each other. Other configurations other than above are approximately the same as those in the first embodiment described above and their descriptions are omitted accordingly.

In the second embodiment, on the TFT substrate 41 are formed a plurality of transparent pixel electrodes 42₁₁, 42₁₂, . . . , in a matrix form and, in an area surrounding each of the plurality of transparent pixel electrodes 42₁₁, 42₁₂, . . . , are provided each of the scanning lines Gₘ to supply scanning signals and each of the signal lines Dₙ to supply displaying signals so that each of the scanning lines Gₘ and each of the signal lines Dₙ intersect at right angles. Each of the driving TFTs 43ₘₙ and each of the light receiving TFTs 44ₐₘₙ and 44_{bmn} are formed in the vicinity of each intersection of each of the scanning lines Gₘ and each of the signal lines Dₙ. A source electrode of each of the driving TFTs 43ₘₙ is connected to each of the transparent pixel electrodes 42ₘₙ and each of the driving TFTs 43ₘₙ is used as each switching element to apply a signal charge to each corresponding liquid crystal cell. Each of the light receiving TFTs 44ₐₘₙ and 44_{bmn} is used as a coordinate position detecting device (light receiving device) to receive light emitted from the light pen R.

Each of the driving TFTs 43ₘₙ is driven and controlled by inputting of a scanning signal through each of the scanning lines Gₘ to a gate electrode connected to each of the scanning lines Gₘ and by inputting of a displaying signal (data signal) to a drain electrode connected to each of the signal lines Dₙ. Also, the source electrode of each of the driving TFTs 43ₘₙ is connected through each of contact holes to each of the transparent pixel electrode 42ₘₙ. In the embodiment, each of the light receiving sections 44ₘₙ is made up of a pair of each of the light receiving TFTs 44_{bmn} and each of the light receiving TFTs 44_{bmn} in which each of the light receiving TFTs 44ₐₘₙ and each of the light receiving TFTs 44_{bmn} are connected to each other. That is, a gate electrode of each of the light receiving TFTs 44ₐₘₙ is connected to its own source electrode and to the gate electrode and drain electrode of each of the light receiving TFTs 44_{bmn} and the drain electrode of the light receiving TFTs 44_{bmn} is connected to the signal lines Dₙ and the source electrode of the light receiving TFTs 44_{bmn}. is connected to its own gate electrode and the gate electrode and drain electrode of each of the light receiving TFTs 44_{bmn}.

The gate electrode of each of the light receiving TFTs 44_{bmn} is connected to its own drain electrode and to the gate electrode and source electrode of the light receiving TFTs 44ₐₘₙ and the drain electrode of each of the light receiving TFTs 44_{bmn} is connected to its own gate electrode and the gate electrode and source electrode of the light receiving TFTs 44ₐₘₙ and the source electrode of each of the light receiving TFTs 44_{bmn} is connected to the scanning lines Gₘ.

As shown in FIGS. 8 and 9, in the TFT substrate 41, a gate electrode 47 is formed on the transparent insulating substrate 46ₘₙ The gate electrode 47 is coated with a gate insulating film 48ₘₙ A semiconductor layer 49 is formed on the gate insulating film 48 on an upper side of the gate electrode 47ₘₙ Drain/source electrodes 51 are formed on the gate insulating film 48 in a manner in which the drain/source electrodes 51 are in contact with the semiconductor layer 49. The gate insulating film 48, semiconductor layer 49, and drain/source electrodes 51 are coated with a passivation film 54. Specified regions of the passivation film 24 are coated with an ITO film 55.

Moreover, in FIG. 8, each of the contact holes on the drain electrode 22 side and the source electrode 23 side is shown by the reference marks “Hc” and each of the contact holes on the gate electrode 47 by the reference marks “Hd”. Here, the scanning lines Gₘ is formed in the same layer as the gate electrode 47 is formed. Also, the gate electrode 47 formed in a region where the light receiving TFTs 44ₐₘₙ and 44_{bmn} are arranged intercepts illuminating light emitted from the backlight 4 to perform also a function of preventing the light receiving TFTs 44ₐₘₙ and 44_{bmn} from being irradiated with needless light.

Thus, according to configurations of the embodiment, approximately the same effect as obtained in the first embodiment can be achieved.

### Third Embodiment

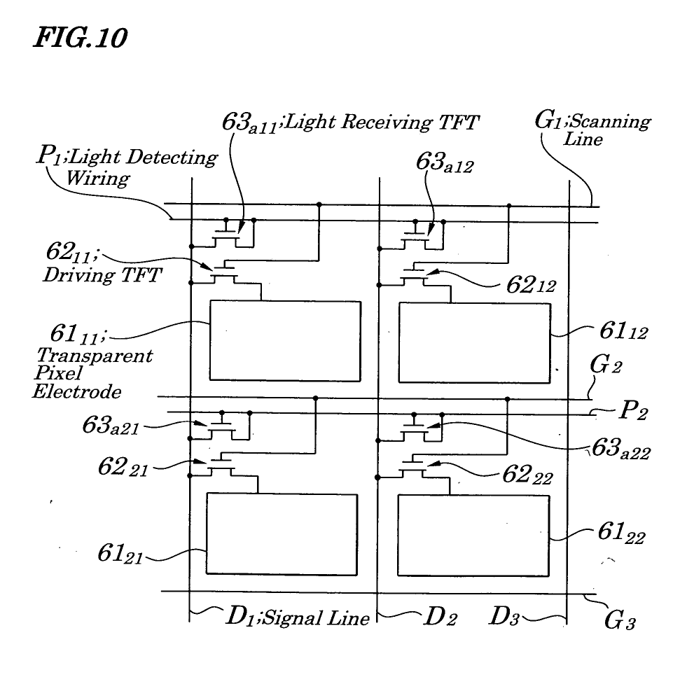

FIG. 10 is an equivalent circuit diagram showing electrical configurations of a liquid crystal panel of the third embodiment of the present invention. Configurations of the third embodiment differ greatly from those of the first embodiment in that each of light receiving section TFTs is made up of a single light receiving TFT and each of the light receiving TFTs is connected to signal lines and to each of light detecting wirings provided in parallel to the scanning lines, instead of the scanning lines used in the first and second embodiments. Configurations other than above are approximately the same as those in the first embodiment described above and their descriptions are omitted accordingly.

As shown in FIG. 10, on the TFT substrate 41 of the embodiment are formed a plurality of transparent pixel electrodes 6₁₁, 61₁₂, . . . , in a matrix form and, in an area surrounding each of the plurality of transparent pixel electrodes 61₁₁, 61₁₂, . . . , are provided each of the scanning lines Gₘ to supply scanning signals and each of the signal lines Dₙ to supply displaying signals, and each of light detecting wirings Pₘ to detect light input so that each of the scanning lines Gₘ in parallel to which each of the light detecting wirings Pₘ is provided and each of the signal lines Dₙ intersect at right angles. Each of the driving TFT 62ₘₙ and each of the light receiving TFTs 63ₐₘₙ are formed in the vicinity of each intersection of each of the scanning lines Gₘ (and each of the light detecting wirings Pₘ) and each of the signal lines Dₙ. A source electrode of each of the driving TFTs 62ₘₙ is connected to each of the transparent pixel electrodes 61ₘₙ and is used as a switching element to apply signal charges to corresponding liquid crystal cells and each of the light receiving TFTs 63ₐₘₙ is used as a light receiving device to receive light emitted from the light pen R.

Each of the driving TFTs 62ₘₙ is driven and controlled by inputting of scanning signals through each of the scanning lines Gₘ to its gate electrode connected to each of the scanning lines Gₘ and by inputting of displaying signals (data signals) to its drain electrode connected to each of the signal lines Dₙ. Also, a source electrode of the driving TFTs 62ₘₙ is connected to each of the transparent pixel electrode 61ₘₙ through contact holes. In the embodiment, each of the light receiving sections is made up of each of single light receiving TFTs 63ₐₘₙ. A gate electrode of each of the light receiving TFTs 63ₐₘₙ is connected to its own source electrode and to each of the light detecting wirings Pₘ and a drain electrode of each of the light receiving TFTs 63ₐₘₙ is connected to each of the signal lines Dₙ and its source electrode is connected to its own gate electrode and each of the light detecting wirings Pₘ. In the embodiment, each of the detecting wirings Pₘ is maintained at a high potential and each of the signal lines Dₙ is maintained at a low potential.

The controlling section 35 performs operations of writing to each pixel and selects the light receiving sections which are not performing operations of writing to each of corresponding pixels (that is, the light receiving section corresponding to each of the pixels in an OFF state) and, in order to detect presence or absence of light input, controls so as to form a closed circuit by the selected light receiving section, each of the corresponding light detecting wirings Pₘ, signal lines Dₙ, and corresponding current measuring circuit of the light input detecting section.

Thus, according to the configurations as above, approximately the same effect as obtained in the first embodiment can be achieved. In addition, since each of the light detecting wirings Pₘ is provided independently, writing of data to pixels and reading of optical currents emitted from each of the light receiving TFTs 63ₐₘₙ can be performed also independently (for example, at the same time).

It is apparent that the present invention is not limited to the above embodiments but may be changed and modified without departing from the scope and spirit of the invention. For example, the case in which the gate electrode is made of chromium is described in the above embodiments, however, the gate electrode may be made of metal such as aluminum, tantalum, molybdenum, or a like, instead of chromium.

Also, a semiconductor on which the doped n-type a-Si layer is formed, instead of the non-doped a-Si layer, may be used. The external input terminal sections formed in an area surrounding each of the TFTs may be configured, if necessary, so that, for example, each of the scanning lines and each of the signal lines are made to be at the same potential. A flat panel speaker (FPS) made of transparent members and having a vibrating plate serving also as a screen member to protect the liquid crystal display panel and an actuator module having a piezoelectric device to vibrate a vibrating plate to emit sound waves. Moreover, as a light source unit of the backlight, not only an LED but also an aperture-type fluorescent lamp or a like may be used. Also, as the LED, not only a white LED but also a single color LED may be used. As a point-like light source, not only the LED but also an incandescent lamp may be employed.

Moreover, in the first embodiment, the case is described in which, in areas other than those connected to scanning lines and signal lines connected to writing areas, simultaneous measurement in a column unit or in a row unit is made and switching scanning is also performed, however, measurement not only in the column unit or in the row unit, but also in every specified group may be made. Also, not only measurement by switching in one unit but also simultaneous measurement of all measurable areas may be employed. Moreover, it is not necessary that there is a one-to-one correspondence between each of the driving TFTs and the light receiving TFTs and each of the driving TFTs and each of the light receiving TFTs may be independently arranged.

In the above embodiments, the case is described in which each of the current measuring circuits measures currents flowing through the plurality (the number of scanning lines “m”) of the light receiving sections 7ₘₙ to the same signal lines Dₙ by switching currents in a column unit, however, the currents may be measured in a row unit. Also, one of the scanning lines Gₘ to be obtained by changing the row number “m” in increasing order from 1 is selected and performs writing processing after the completion of light input detecting processing.

Also, after the completion of writing processing for all scanning lines Gₘ. light input detecting processing may be performed by changing rows for all the light receiving sections 7ₘₙ. As the CVD method, for example, an atmospheric pressure CVD method, low pressure CVD method, PECVD (Plasma Enhanced Chemical Vapor Deposition), or a like can be employed.

Furthermore, the semiconductor layer may be formed not only by amorphous silicon but also polysilicon.

What is claimed is:

1. A liquid crystal display device with a tablet function comprising:
scanning lines to which scanning signals are applied;
signal lines to which displaying signals are applied;
pixel electrodes arranged in a matrix form to apply voltages to a liquid crystal layer;
switching elements each comprising a field effect transistor formed in a vicinity of each intersection of each of said scanning lines and each of said signal lines to switch a displaying signal to be applied to corresponding one of said pixel electrodes by using scanning signals; and
coordinate position detecting devices each formed in a manner to correspond to at least part of each of said pixel electrodes to output a coordinate position detecting signal to specify a coordinate position designated by a position designating unit when receiving light emitted through a display screen from said position designating unit;
wherein said coordinate position detecting devices comprise field effect transistors.

2. The liquid crystal display device with the tablet function according to claim 1, wherein a gate electrode of each of said coordinate position detecting devices is connected to its own drain electrode or its own source electrode.

3. The liquid crystal display device with the tablet function according to claim 2, wherein a pair of said coordinate position detecting devices are formed so as to be symmetric with each other using said drain electrode or source electrode as common electrodes.

4. The liquid crystal display device with the tablet function according to claim 1, wherein each of said switching elements and each of said coordinate position detecting devices have approximately the same layered structure.

5. The liquid crystal display device with the tablet function according to claim 1, further comprising an optical current measuring unit to receive said coordinate position detecting signals and to measure optical currents generated by said coordinate position detecting devices.

6. The liquid crystal display device with the tablet function according to claim 2, further comprising first wirings and second wirings connected to said coordinate position detecting devices to read said coordinate position detecting signals output from said coordinate position detecting devices, wherein each of said coordinate position detecting devices is formed in a vicinity of each intersection of each of said first wirings and each of said second wirings and said drain electrode or said source electrode of each of said coordinate position detecting devices is connected to each of said first wirings or each of said second wirings.

7. The liquid crystal display device with the tablet function according to claim 6, further comprising a driving controlling unit to select said coordinate position detecting devices to detect presence or absence of light input and to connect said optical current measuring unit to the selected coordinate position detecting devices through said first wirings and said second wirings and a coordinate position specifying unit to specify coordinate positions input by designation of said position designating unit based on said coordinate position detecting signals output from said coordinate position detecting devices.

8. The liquid crystal display device with the tablet function according to claim 6, wherein each of said scanning lines or each of said signal lines serves as at least one out of each of said first wirings and each of said second wirings.

9. The liquid crystal display device with the tablet function according to claim 8, wherein each of said coordinate detecting devices is connected to each of said scanning lines serving as each of said first wirings and to each of said signal lines serving as each of said second wirings.

10. The liquid crystal display device with the tablet function according to claim 7, wherein said driving controlling unit, during a writing suspending period in which said switching elements are in an OFF state, selects said coordinate position detecting devices corresponding to said switching elements as coordinate detecting devices being objects of reading coordinate position detecting signals.

11. The liquid crystal display device with the tablet function according to claim 1, wherein a semiconductor of each of said coordinate position detecting devices comprises a first amorphous silicon layer which is not doped with an impurity and a second amorphous silicon layer which is formed on said first amorphous silicon layer and is doped with an n-type or p-type impurity.

12. The liquid crystal display device with the tablet function according to claim 1, wherein said position designating unit comprises a light pen.

13. The liquid crystal display device with the tablet function according to claim 6, further comprising a driving controlling means to select said coordinate position detecting devices to detect presence or absence of light input and to connect said optical current measuring means to the selected coordinate position detecting devices through said first wirings and said second wirings and a coordinate position specifying means to specify coordinate positions input by designation of said position designating means based on said coordinate position detecting signals output from said coordinate position detecting devices.

14. A liquid crystal display device with a tablet function comprising:
scanning lines to which scanning signals are applied;
signal lines to which displaying signals are applied;
pixel electrodes arranged in a matrix form to apply voltages to a liquid crystal layer;
switching elements each comprising a field effect transistor formed in a vicinity of each intersection of each of said scanning lines and each of said signal lines to switch a displaying signal to be applied to corresponding one of said pixel electrodes by using scanning signals; and
coordinate position detecting devices each formed in a manner to correspond to at least part of each of said pixel electrodes to output a coordinate position detecting signal to specify a coordinate position designated by a position designating means when receiving light emitted through a display screen from said position designating unit;
wherein said coordinate position detecting devices comprise field effect transistors.
